(19) United States
(12) Patent Application Publication
(10) Pub. No.: US 2011/0123722 A1
(43) Pub. Date: May 26, 2011

(54) LIGHT-GUIDE INK, USING METHOD AND MANUFACTURING METHOD OF THE SAME

(75) Inventors: Jiuxia YANG, Beijing (CN); Yanying LV, Beijing (CN)

(73) Assignee: BOE TECHNOLOGY GROUP CO., LTD., Beijing (CN)

(21) Appl. No.: 12/954,054

(22) Filed: Nov. 24, 2010

(30) Foreign Application Priority Data
Nov. 26, 2009 (CN) 200910241577.0

(51) Int. Cl. C09D 11/10; B05D 5/00; B05D 3/06

(52) U.S. Cl. 427/511; 427/256; 522/81; 522/82; 522/83

(57) ABSTRACT

Light-guide ink comprising: scattering particles of 2-25 parts by weight; a resin of 10-50 parts by weight; a pigment of 0.01-0.5 parts by weight; a solvent of 20-75 parts by weight; a photoinitiator of 0-8.5 parts by weight; and an additive of 0.01-3.5 parts by weight.

### BACKGROUND

Embodiments of the invention relate to light-guide ink for a light-guide plate used in a liquid crystal display (LCD) backlight module and a using method and manufacturing method of the same.

A LCD device comprises a LCD panel and a backlight module that provides a light source for the LCD panel. The backlight module usually employs a light-guide plate to evenly direct the light emitted from a light source to the LCD panel of the LCD device. On the back face of the light-guide plate there are provided ink patterns. When the light irradiates on the ink patterns, diffuse reflection occurs. With the light-guide plate, a linear light source (or dot light sources) can be converted into an area light source that can irradiate the whole LCD panel at the same time. Currently, the material for manufacturing a light-guide plate typically comprises poly(methyl methacrylate) resin (PMMA) or cyclic olefin polymer resin (COP); however these materials' heat resistance is poor. Generally the heat distortion temperature of the PMMA light guide plate is about 90 centigrade. Therefore, it is required that the temperature at which the ink patterns are cured should be lower than the deformation temperature of the light guide plate and that the color shift upon curing should be avoided so as to prevent the color characteristics of LCD devices from being degraded.

### SUMMARY

An embodiment of the present invention provides a light-guide ink comprising scattering particles of 2-25 parts by weight; a resin of 10-50 parts by weight; a pigment of 0.01-0.5 parts by weight; a solvent of 20-75 parts by weight; a photoinitiator of 0-8.5 parts by weight; and an additive of 0.01-3.5 parts by weight.

Another embodiment of the present invention provides a method for preparing a light-guide ink, including: step 1, adding about 5% to 50% of a solvent of 20-75 parts by weight to a resin of 10-50 parts by weight and mixing well to prepare a resin solution; step 2, adding scattering particles of 2-25 parts by weight and a pigment of 0.01-0.5 parts by weight to the resin solution, and obtaining a pre-dispersed solution after pre-dispersion; step 3, dispersing the pre-dispersed solution to obtain a dispersion of scattering particles; step 4, adding a photoinitiator of about 0-8.5 parts by weight, the remaining about 50% to 95% of the solvent of 20-75 parts by weight from step 1, and an additive of 0.01-3.5 parts by weight to the dispersion of scattering particles, and mixing well to obtain the light-guide ink.

Yet another embodiment of the present invention provides a method of using the above light-guide ink, which comprises coating the light-guide ink onto the back face of a light-guide plate to get an ink pattern after curing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### DETAILED DESCRIPTION

In one embodiment of the present invention, a light-guide ink comprises scattering particles of 2-25 parts by weight; a resin of 10-50 parts by weight; a pigment of 0.01-0.5 parts by weight; a solvent of 20-75 parts by weight; a photoinitiator of 0-8.5 parts by weight; and an additive of 0.01-3.5 parts by weight.

The material properties of scattering particles affect the refractive index of the light-guide ink. Low refractive index results in a weak scattering and can not evenly direct the light, whereas high refractive index results in a strong light scattering and could easily lead to light losses. Small particle size is difficult to achieve light scattering and reduces the brightness of light-guide plate, whereas large particle size is easy to induce light losses due to back reflection and also leads to decrease in brightness. In an illustrative embodiment of the invention, examples of scattering particles include titanium dioxide, barium sulfate, magnesium oxide, silicon oxide, zinc oxide, lithopone or zirconia. The particle size of scattering particles is in the range of about 40-400 nm.

In an illustrative embodiment of the invention, examples of the resin include resin formed of unsaturated vinyl monomer (such as acrylate, polyester acrylate oligomer, or epoxy acrylate), epoxy resins, thermosetting resins, thermoplastic resin, and so on. By thermal curing or ultra violet (UV) curing (depending on the nature of the selected resin), the resin can have a good adhesion with the material of the light-guide plate, and the curing temperature of the resin, about 50-80 centigrade, is lower than the heat distortion temperature of the light-guide plate material (about 90 centigrade).

In an embodiment of the invention, a pigment can be incorporated into light-guide ink to compensate color shift which may occur in a backlight module. The light from the light source in the backlight module may be absorbed in a certain wave band due to yellowing of the light-guide ink upon curing, and the resultant color shift can be compensated by incorporating a certain amount of nanometer pigment(s) to absorb the light at other wavelengths so as to have the color of the light emitted out of the backlight module balanced. Examples of pigments useful in the embodiment include a mixture of two or more pigments selected from the group consisting of red pigment, green pigment, blue pigment, violet pigment and black pigment. The pigments are mixed to compensate for yellowing according to color theory.

Examples of the red pigment include P.R.122, P.R.123, P.R.177, P.R.179, P.R.190, P.R.202, P.R.210, P.R.224, P.R.254, P.R.255, P.R.264, P.R.270, or P.R.272.

Examples of the green pigment include P.G.37, P.G.36, or P.G.7. Examples of the blue pigment include P.B.15, P.B.15:3, P.B.15:6, P.B.15:4, P.B.1, P.B.2, P.B.22, P.B.16, P.B.60, or P.B.66.

Examples of the violet pigment include P.V.32, P.V.36, P.V.38, P.V.39, P.V.23, P.V.9, or P.V.1. Examples of the black pigment include C.I.1 or C.I.7.

Here, “P.R.” refers to pigment red, “P.G” refers to pigment green, “P.B.” refers to pigment blue, “P.V.” refers to pigment violet, “C.I.” refers to china iron oxide black, and all these are pigment codes from the Color Index.

In an embodiment of the invention, the solvent can be used to dissolve various components of the light-guide ink and allow these components uniformly mixed and completely dissolved. Examples of the solvent include: acidic solvents, such as formic acid, acetic acid and chloroform; alkaline solvents, such as ketones, esters and ethers; and neutral solvents, such as aliphatic hydrocarbons, cyclic alkanes and aromatic hydrocarbons. For example, the solvent can be aliphatic alcohol, glycol ether, ethyl acetate, methyl ethyl ketone, methyl isobutyl ketone, ethylene glycol monomethyl ether acetate, γ-butyrolactone, ethyl 3-ethoxypropionate, butyl carbitol, butyl carbitol acetate, propylene glycol monomethyl ether, propylene glycol monomethyl ether acetate, cyclohexane, xylene, or isopropyl alcohol. It is preferred that the solvent is cyclohexanone, propylene glycol monomethyl ether acetate, cyclohexane, xylene, butyl carbitol, butyl carbitol acetate, ethyl 3-ethoxypropionate, γ-butyrolactone, or any combination of the foregoing solvents.

In an embodiment of the invention, the photoinitiator can be used to generate the free radicals or ions that can initiate polymerization. The photoinitiator used can be a free radical photoinitiator, a cationic photoinitiator, or a mixture of a free radical photoinitiator and a cationic photoinitiator. For example, the photoinitiators may include: ketone oxime ester photoinitiators, α-amino ketone photoinitiators, acetophenone photoinitiators, acyl phosphine oxides, aromatic ketone photoinitiators, aromatic sulfonium salts, iodonium salts, ferrocenium salts, or any combination thereof. Useful acetophenone photoinitiators include sulfur based acetophenone photoinitiators with tertiary amino group of morpholine and sulfide group in the molecule which exhibit a synergistic effect in combination with thioxanthone. Useful aromatic ketone photoinitiators include: 2-phenylbenzyl-2-dimethylamino-1-(4-morpholino-benzylphenyl)butanone, benzophenone and its derivatives, methyl o-benzoyl benzoate, and thioxanthone. Furthermore, useful photoinitiators can include ferrocene salts and small molecule onium salts, such as aromatic sulfonium salts (for example, aromatic sulfonium salts available as product models UVI-6976 and UVI-6992), iodonium salt (for example, iodonium salts available as product model IRGACURE 250), triphenyl sulfonium salts, diaryl iodonium salts, η6-cumene ferrocene oxide complexs, and η6-pyrene ferrocene oxide complexs; macromolecular photoinitiators, such as: cationic onium salts containing long-chain alkyl, alkoxy, or ester groups, salts containing cationic groups of polyurethane, salts containing polycyclic aromatic cations, and so on.

Examples of the additive useful in the embodiment include surfactants, leveling agents, wetting agents, adhesion promoters, anti-oxidants, UV absorbers, anti-flocculants, defoamers, stabilizers, or any combination thereof.

Example of Light-Guide Ink

In an embodiment of the invention, the method for preparing light-guide ink includes: step 1, adding about 5% to 50% of solvent of 20-75 parts by weight to a resin of 10-50 parts by weight and having them mixed well to prepare a resin solution;

step 2, adding scattering particles of 2-25 parts by weight and a pigment of 0.01-0.5 parts by weight to the resin solution, and obtaining a pre-dispersed solution after pre-dispersion via a process such as stirring;

step 3, dispersing the pre-dispersed solution with an equipment such as 3-roller rolling machine to obtain a dispersion of scattering particles with a particle size distribution in the range of about 40-400 nm; and

step 4, adding a photoinitiator of 0-8.5 parts by weight, the remaining about 50% to 95% of the solvent of 20-75 parts by weight, and an additive of 0.01-3.5 parts by weight into the dispersion of scattering particles, and having them mixed well via a process such as stirring to obtain the light-guide ink.

Light-guide inks are manufactured according to the examples 1-12 shown in the following Tables 1 and 2.

TABLE 1

| | | Example # | | | | | |
|---|---|---|---|---|---|---|---|
| Component(g) | | 1 | 2 | 3 | 4 | 5 | 6 |
| Resin | EBE 264 | 12 | — | 5 | 10 | — | — |
| | DPHA | — | — | — | — | 7 | 8 |
| | SB 401 | 14 | — | 5 | 11 | 13 | 20 |
| | A11 | — | 26 | — | — | — | — |
| Pigment | Red Pigment P.R.177 | 0.05 | 0.02 | 0.1 | 0.02 | 0.1 | 0.1 |
| | Blue Pigment P.B15 | 0.05 | 0.01 | 0.12 | 0.03 | 0.12 | 0.2 |
| | Green Pigment P.G7 | 0.05 | 0.02 | 0.12 | 0.03 | 0.12 | 0.2 |
| Solvent | PMA | 64.34 | 18.45 | 29 | 73.88 | 73.44 | 59.69 |
| | Cyclohexanone | — | 30 | 34.66 | — | — | — |
| Photo- | Irgacure 379 | 3.5 | — | — | 2 | 0.4 | 0.8 |
| initiator | Irgacure OXE01 | — | — | — | 1 | 0.8 | 1 |
| Additive | HALS (Stabilizer) | 0.01 | — | — | 0.04 | — | 0.01 |
| | BYK-057 (Defoamer) | — | 0.5 | 1 | — | 0.02 | — |
| Scattering | Titanium Dioxide | 3 | 12.5 | 15 | 2 | — | — |
| Particle | Silicon Oxide | — | — | — | — | 5 | — |
| | Barium Sulfate | — | — | — | — | — | 10 |
| | Lithopone | — | — | — | — | — | — |
| | Zirconia | 3 | 12.5 | 10 | — | — | — |

TABLE 2

| | | Example # | | | | | |
|---|---|---|---|---|---|---|---|
| Component(g) | | 7 | 8 | 9 | 10 | 11 | 12 |
| Resin | EBE 264 | 7.5 | 27 | 12 | 20 | — | — |
| | DPHA | 7.5 | — | 4 | — | — | — |
| | SB 401 | 15 | 20 | 34 | 20 | — | — |
| | A11 | — | — | — | — | 15 | 35 |
| Pigment | Black Pigment C.I.1 | 0.2 | 0.1 | 0.2 | 0.1 | 0.015 | 0.025 |
| | Blue Pigment P.B15 | — | 0.1 | 0.1 | 0.2 | 0.01 | 0.015 |
| | Violet Pigment P.V.32 | 0.3 | 0.3 | 0.2 | 0.2 | 0.012 | 0.028 |
| Solvent | PMA | 46 | 21.2 | 21.25 | 24.25 | 47.663 | — |
| | Cyclohexanone | — | — | — | — | 22 | 39.132 |
| Photo- | Irgacure 379 | 3 | 6.5 | 2.5 | 6.75 | — | — |
| initiator | Irgacure OXE01 | 1.5 | 2 | 0.25 | 0.5 | — | — |
| Additive | HALS (Stabilizer) | 2 | — | — | — | — | — |
| | BYK-057 (Defoamer) | — | 2.8 | 3.5 | 3 | 0.3 | 0.8 |
| Scattering | Titanium Dioxide | — | — | — | 25 | 7.5 | 10 |
| Particle | Silicon Oxide | — | — | 22 | — | — | — |
| | Barium Sulfate | — | — | — | — | — | — |
| | Lithopone | 17 | — | — | — | — | — |
| | Zirconia | — | 20 | — | — | 7.5 | 15 |

### Comparative Examples

As shown in Table 3, the components of the comparative examples are same as those of Examples 6 and 9 of the embodiment except for the contents of pigments. These comparative examples are manufactured with a conventional method.

TABLE 3

| | | Comparative Example # | | | |
|---|---|---|---|---|---|
| Component(g) | | 1 | 2 | 3 | 4 |
| Resin | EBE 264 | — | — | 4 | 12 |
| | DPHA | 8 | 8 | 12 | 4 |
| | SB 401 | 20 | 20 | 34 | 34 |
| | A11 | — | — | — | — |
| Pigment | Black PigmentC.I.1 | — | — | 0.002 | 0.6 |
| | Blue Pigment P.B15 | — | — | 0.002 | 0.5 |
| | Violet Pigment P.V.32 | 1 | — | — | 0.5 |
| Solvent | PMA | 59.69 | 59.69 | 21.25 | 21.25 |
| | Cyclohexanone | — | — | — | — |
| Photo- | Irgacure 379 | 0.8 | 0.8 | 2.5 | 2.5 |
| initiator | Irgacure OXE01 | 1 | 1 | 0.25 | 0.25 |
| Additive | HALS (Stabilizer) | 0.01 | 0.01 | — | — |
| | BYK-057 (Defoamer) | — | — | 3.5 | 3.5 |
| Scattering | Titanium Dioxide | — | — | — | — |
| Particle | Silicon Oxide | — | — | 22 | 22 |
| | Barium Sulfate | 10 | 10 | — | — |
| | Lithopone | — | — | — | — |
| | Zirconia | — | — | — | — |

Curing Temperature Test

The method of using a light-guide ink of the embodiment of the present invention comprises: applying the light-guide ink by the technique such as screen printing, spin coating, slit-spin combined coating, or inkjet printing, onto the back face of a light guide plate, and obtaining an ink pattern after thermal curing at a certain temperature or UV curing. UV curing is employed in the examples, except that thermal curing is used in examples 2, 11 and 12 due to the presence of thermosetting resin in examples 2, 11 and 12. In Table, “TC” refers to “Thermal Curing.”

Ink patterns are formed on light-guide plates by using the light-guide ink of the above Examples 1-12 and Comparative Examples 1-4 through the above method. Their curing temperatures and times are measured, and the results are shown in the Table 4.

TABLE 4

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Curing | 35 | <60 | 35 | 35 | 35 | 35 | 35 | 35 | 35 | 35 | 50 | 70 |
| Temperature (° C.) | | | | | | | | | | | | |
| Time (s) | 20 | 1800 | 20 | 20 | 20 | 20 | 20 | 20 | 20 | 20 | 1800 | 3800 |
| Exposure Dose | 24 | TC | 24 | 24 | 24 | 24 | 24 | 24 | 24 | 24 | TC | TC |
| (mW/cm²) | | | | | | | | | | | | |

As can be seen from Table 4, since UV curing process or thermal curing process which employs the materials with a low curing temperature is used in the present invention, the curing temperature in the present invention is below the deformation temperature of the light guide plate. It can be seen that thermal curing at a temperature of 40-80 degrees for 0.5˜2 h can achieve a complete cure without deformation of light guide plate, and the thermal curing process can adopt any conventional process; also lower curing temperature and shorter time is required for UV curing compared with conventional light-guide ink.

Color Shift Test

Ink patterns are formed on light-guide plates by using the light-guide ink of the above Comparative Examples through the conventional method. The light guide plates using the light guide ink of the above examples of the embodiment and the light guide plate using the light guide ink of the comparative examples are applied to a backlight module under the same conditions. The observed results whether color shift occurs are shown in the Table 5.

TABLE 5

| | | | | | | | | | | | | | Comparative | | | |
|---|---|---|---|---|---|---|---|---|---|---|---|---|---|---|---|---|
| | Example | | | | | | | | | | | | Example | | | |
| | 1 | 2 | 3 | 4 | 5 | 6 | 7 | 8 | 9 | 10 | 11 | 12 | 1 | 2 | 3 | 4 |
| color shift | ◯ | ◯ | ◯ | ◯ | Δ | Δ | Δ | Δ | Δ | Δ | ◯ | ◯ | X | X | X | X |
| extent | | | | | | | | | | | | | | | | |

Note:
“◯”: no color shift; “X”: severe color shift; “Δ”: slight color shift.

As can be seen from Table 5, the color shift phenomenon, serious yellowing, occurs in the Comparative Examples 1-4 which is cured into film by UV curing. In Examples 1-12 of the present invention, compensation by adding pigments to the light-guide ink reduces or prevents to various extents the color shift of the light source from the light-guide plate.

The embodiments of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. A light-guide ink, comprising:
scattering particles of 2-25 parts by weight;
a resin of 10-50 parts by weight;
a pigment of 0.01-0.5 parts by weight;
a solvent of 20-75 parts by weight;
a photoinitiator of 0-8.5 parts by weight; and
an additive of 0.01-3.5 parts by weight.

2. The light-guide ink according to claim 1, wherein the scattering particles are selected from the group consisting of titanium dioxide, barium sulfate, magnesium oxide, silicon oxide, zinc oxide, lithopone and zirconia.

3. The light-guide ink according to claim 2, wherein the scattering particles have a particle size in the range of about 40-400 nm.

4. The light-guide ink according to claim 1, wherein the pigment is a mixture of two or more pigments selected from the group consisting of red pigment, green pigment, blue pigment, violet pigment and black pigment.

5. The light-guide ink according to claim 4, wherein the red pigment comprises P.R.122, P.R.123, P.R.177, P.R.179, P.R.190, P.R.202, P.R.210, P.R.224, P.R.254, P.R.255, P.R.264, P.R.270, or P.R.272;
the green pigment comprises P.G.37, P.G.36, or P.G.7;
the blue pigment comprises P.B.15, P.B.15:3, P.B.15:6, P.B.15:4, P.B.1, P.B.2, P.B.22, P.B.16, P.B.60, or P.B.66;
the violet pigment comprises P.V.32, P.V.36, P.V.38, P.V.39, P.V.23, P.V.9, or P.V.1; and
the black pigment comprises C.I.1 or C.I.7.

6. The light-guide ink according to claim 1, wherein the resin is selected from the group consisting of resin formed of unsaturated vinyl monomers, epoxy resin, thermosetting resin, and thermoplastic resin.

7. The light-guide ink according to claim 6, wherein the unsaturated vinyl monomer is selected from the group consisting of acrylate, polyester acrylate oligomer, and epoxy acrylate.

8. The light-guide ink according to claim 1, wherein the resin is thermosetting resin or thermoplastic resin.

9. The light-guide ink according to claim 1, wherein the additive is selected from the group consisting of dispersing agent, leveling agent, wetting agent, adhesion promoter, anti-oxidants, UV absorbers, anti-flocculants, defoamers, stabilizer, and any combination thereof.

10. The light-guide ink according to claim 1, wherein the solvent is selected from the group consisting of cyclohexanone, aliphatic alcohols, glycol ether, ethyl acetate, methyl ethyl ketone, methyl isobutyl ketone, ethylene glycol monomethyl ether acetate, γ-butyrolactone, ethyl 3-ethoxypropionate, butyl carbitol, butyl carbitol acetate, propylene glycol monomethyl ether, propylene glycol monomethyl ether acetate, cyclohexane, xylene, isopropyl alcohol, and any combination thereof.

11. The light-guide ink according to claim 1, wherein the photoinitiator comprises a free radical photoinitiator, a cationic photoinitiator, or a mixture thereof.

12. A method for preparing a light-guide ink, including:
step 1, adding about 5% to 50% of a solvent of 20-75 parts by weight to a resin of 10-50 parts by weight and mixing them to prepare a resin solution;
step 2, adding scattering particles of 2-25 parts by weight and a pigment of 0.01-0.5 parts by weight to the resin solution and obtaining a pre-dispersed solution through pre-dispersing;
step 3, dispersing the pre-dispersed solution to obtain a dispersion of scattering particles; and
step 4, adding photoinitiator of 0-8.5 parts by weight, the remaining about 50% to 95% of the solvent of 20-75 parts by weight from step 1, and an additive of 0.01-3.5 parts by weight to the dispersion of scattering particles and mixing them to obtain the light-guide ink.

13. The method according to claim 12, wherein the scattering particles in the dispersion of scattering particles obtained by dispersing the pre-dispersed solution have a particle size distribution in the range of about 40-400 nm.

14. A method of using light-guide ink according to claim 1, comprising:
applying the light-guide ink onto the back face of a light-guide plate to form an ink pattern after curing.

15. The method according to claim 14, wherein the light-guide ink coated is heat-cured at a temperature of about 40-80 degree for 0.5 h˜2 h to form the ink pattern.

16. The method according to claim 14, wherein the light-guide ink coated is UV-cured to form the ink pattern.
